(19) United States
(12) Patent Application Publication
(10) Pub. No.: US 2015/0100171 A1
(43) Pub. Date: Apr. 9, 2015

(54) LOAD CONTROL METHOD, LOAD CONTROL DEVICE, AND ELECTRICAL LOAD DEVICE

(71) Applicant: Panasonic Intellectual Property Management Co., Ltd., Osaka (JP)

(72) Inventors: Mahdi Behrangrad, Osaka (JP); Masami Funakura, Osaka (JP)

(21) Appl. No.: 14/400,564

(22) PCT Filed: Mar. 28, 2014
(86) PCT No.: PCT/JP2014/001820

§ 371 Date: Nov. 12, 2014

(30) Foreign Application Priority Data
Mar. 29, 2013 (JP) 2013-074131

(51) Int. Cl. G05F 1/66; H02J 13/00

(52) U.S. Cl. CPC G05F 1/66; H02J 13/0017
USPC 700/291; 700/295; 700/296

(57) ABSTRACT

Load control method suppressing reduction in functionality of a load resource brought about by demand response. The load control method includes: obtaining first time information for specifying demand response commencement time T1 and second time information for specifying ramping completion time T3; determining ramping commencement time T4 based on first time information and second time information; and causing ramping to be commenced at T4. T1 is a time point at which a demand response event is to be commenced. T3 is a time point at which ramping, which is a process through which an amount of electricity received from an electricity grid is changed, is to be completed. T4 is a time point at which ramping is to be commenced. T4 is later than T1 and earlier than T3.

### TECHNICAL FIELD

The present invention relates to a load control method for controlling load during a demand response event.

### BACKGROUND ART

Recently, a mechanism referred to as demand response (DR) is being introduced into electricity supply systems. Demand response balances electricity demand and supply, by adjusting the amount of electricity that a demander demands in relation to the amount of electricity that a supplier is capable of supplying. One example of a supplier of electricity is an electric utility.

In a typical demand response event, load is changed through control by a demand response aggregator (simply referred to in the following as an aggregator). The aggregator mediates between an electricity supplier and at least one electricity demander. For example, when receiving a request to reduce consumption of electricity from the supplier, the aggregator performs control of reducing electric consumption by the demander, who has entered into a DR contract with the aggregator. For example, the aggregator may reduce electric consumption by reducing the amount of electricity consumed by one or more electrical devices possessed by the demander.

### CITATION LIST

### Patent Literature

### Patent Literature 1

Japanese Patent Application Publication No. 2012-065407

### SUMMARY

### Technical Problem

Meanwhile, change in load brought about by a demand response event may result in reduction in functionality of a load resource.

In view of this problem, the present invention aims to provide a load control method and a load control device capable of suppressing reduction in functionality of a load resource brought about by demand response.

### Solution to Problem

One aspect of the present invention is a load control method for controlling a load connected to an electricity grid, the load control method including: obtaining first time information for specifying demand response commencement time and second time information for specifying ramping completion time, the demand response commencement time being a time point at which a demand response event is to be commenced, the ramping completion time being a time point at which ramping in the demand response event is to be completed and being later than the demand response commencement time, the ramping being a process through which an amount of electricity received from the electricity grid is changed; determining ramping commencement time based on the first time information and the second time information, the ramping commencement time being a time point at which the ramping is to be commenced, being later than the demand response commencement time, and being earlier than the ramping completion time; and causing the ramping to be commenced at the ramping commencement time.

Another aspect of the present invention is a load control device for controlling a load connected to an electricity grid, the load control device including: an obtaining unit obtaining first time information for specifying demand response commencement time and second time information for specifying ramping completion time, the demand response commencement time being a time point at which a demand response event is to be commenced, the ramping completion time being a time point at which ramping in the demand response event is to be completed and being later than the demand response commencement time, the ramping being a process through which an amount of electricity received from the electricity grid is changed; and a determining unit determining ramping commencement time based on the first time information and the second time information, the ramping commencement time being a time point at which the ramping is to be commenced, being later than the demand response commencement time, and being earlier than the ramping completion time. The load control device causes the ramping to be commenced at the ramping commencement time.

### Advantageous Effects of Invention

According to such aspects of the present invention, the commencement of the ramping is delayed with respect to the commencement of the demand response event. Consequently, the time period during which the load resource operates at a changed load is shortened. Accordingly, such aspects of the present invention suppress reduction in functionality of a load resource brought about by demand response.

### BRIEF DESCRIPTION OF DRAWINGS

FIG. 1 illustrates one example of system structure of DR system in embodiment 1.

FIG. 2 illustrates one example of timing characteristics in typical demand response event.

FIG. 3 illustrates one example of functional structures of SOA 100 and DRC 200 in embodiment 1.

FIG. 4 illustrates one example of timing characteristics in demand response event where commencement of ramping is delayed.

FIG. 5 illustrates one example of timing characteristics in a demand response event where demand response failure (referred to in the following as “DR failure”) occurs.

FIG. 6 illustrates one example of what constitutes effective ramping period in embodiment 1.

FIG. 7 illustrates an example of modified composition of effective ramping period.

FIG. 8A illustrates one example of probability distribution function (referred to in the following as “PDF”) of intrinsic delay, FIG. 8B illustrates one example of PDF of added delay, FIG. 8C illustrates one example of PDF of ramping delay, FIG. 8D illustrates one example of PDFs of time period of effective ramping period, and FIG. 8E illustrates one example of relationship of DR failure probability to added delay.

FIG. 9A illustrates one example of relationship between indoor temperature and probability of cancellation of demand response event (referred to in the following as “DR cancellation”), FIG. 9B illustrates one example of relationship of indoor temperature to added delay, and FIG. 9C illustrates one example of relationship of DR cancellation probability to added delay.

FIG. 10 explains one example of objective function for calculating profit.

FIG. 11 illustrates information necessary for specifying optimal added delay.

FIG. 12 is a flowchart illustrating operations of SOA 100.

FIG. 13 is a sequence diagram of DR system in embodiment 1.

FIG. 14 illustrates an example of modified functional structures of SOA 100 and DRC 200.

FIG. 15 illustrates a modified example of sequence diagram of DR system.

### DESCRIPTION OF EMBODIMENTS

### Findings by Present Inventors

The following explains the findings that the present inventors have made through research.

In the present disclosure, a load resource is a device that operates while consuming electricity, and may be an electrical device possessed by the demander. For example, the load resource may be a household electrical device such as an air conditioner. In the present disclosure, functionality of the load resource is, for example, a function of the load resource that is available to a user of the load resource (i.e., the demander). For example, when the load resource is an air conditioner, functionality of the load resource is the function of the air conditioner of maintaining a comfortable indoor environment.

Demand response may reduce functionality of the load resource. For example, when the load resource is an air conditioner, the air conditioner may stop or electrical consumption of the air conditioner may be reduced to lower than a predetermined value in a demand response event. In such a case, it may become difficult to maintain a comfortable indoor environment. Due to this, the demander may invalidate control performed by the aggregator in the demand response event or may not participate in the demand response event. In the present disclosure, DR cancellation is a situation where the demander cancels control performed by the aggregator in a demand response event.

When the load resource is an air conditioner, DR cancellation may take place when, for example, the air conditioner stops for a certain time period as a result of a demand response event or when the air conditioner operates with reduced electrical consumption for a certain period as a result of a demand response event. In the present disclosure, a period during which the load resource operates with reduced electrical consumption due to execution of a demand response event, or that is, a period during which the amount of electricity received by the load resource from an electricity grid is reduced due to execution of a demand response event is referred to as a DR period. The longer the DR period, the higher the likelihood of DR cancellation taking place. This is because a long DR period results in a great reduction in functionality of the load resource. For example, when the load resource is an air conditioner, the longer the DR period, the longer the air conditioner stops. Typically, the longer the cooling/heating function of an air conditioner is stopped, the more difficult it becomes to maintain a comfortable indoor environment. Thus, when the load resource is an air conditioner, a longer DR period may result in less comfort for the user of the air conditioner.

As such, shortening the DR period in a demand response event is beneficial for the demander because the reduction in functionality of the load resource can be suppressed. Further, shortening the DR period in a demand response event is also beneficial for the aggregator because it can be expected that the risk of DR cancellation by the user can be reduced, which leads to a reduction in the risk of the aggregator losing an incentive that would otherwise be paid to the aggregator.

Typically, a DR program based on which a demand response event is performed includes specification of DR commencement time at which the demand response event is to be commenced, DR completion time at which the demand response event is to be completed, and a time point in the demand response event at which control of changing the amount of electricity that the load resource receives from the electrical grid is to be completed (referred to in the following as ramping deadline time). In the present disclosure, the time period between the DR commencement time and the ramping deadline time is referred to as a DR preparation period. Further, in the present disclosure, ramping refers to a process, performed in a demand response event, of changing the amount of electricity that the load resource receives from the electrical grid. For example, when the load resource is an air conditioner, ramping performed during the DR preparation period reduces the amount of electricity received by the air conditioner from the electrical grid, whereby the air conditioner stops or operates while consuming a reduced amount of electricity.

The DR preparation period may be several seconds long or several minutes long. When ramping is not completed within the DR preparation period, the aggregator needs to pay a penalty. On the other hand, when ramping is completed within the DR preparation period, the aggregator need not pay a penalty, regardless of how the ramping is performed.

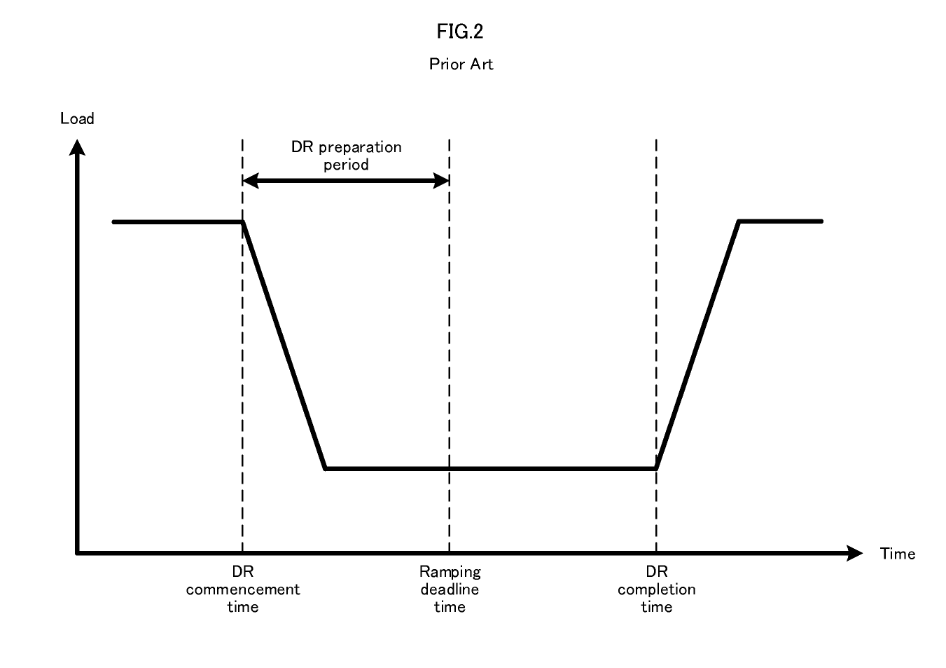

FIG. 2 illustrates one example of a chronological change in demand of electricity in a demand response event.

Note that in a demand response event based on an instruction-based DR program, the DR commencement time is a time point when an electric utility transmits a DR activation signal to the aggregator.

An instruction-based DR program is, for example, a DR program in which a demand response event is performed in an emergency situation, such as when an incident occurs at a power plant.

Meanwhile, in a demand response event based on a schedule-based DR program, the DR commencement time is a time point identified by a DR commencement time identifier that is transmitted prior to the demand response event from the electric utility to the aggregator. Note that in a demand response event based on a schedule-based DR program, the DR commencement time is not the time point when the DR commencement time identifier is transmitted from the electric utility to the aggregator. A schedule-based instruction program is, for example, a DR program in which a demand response event is performed when the amount of electricity demanded by the demander is expected to increase.

In a demand response event, the aggregator receives, from the electric utility, time information for specifying the DR commencement time. The time information, for example, may be the DR activation signal in an instruction-based DR program or the DR commencement time identifier in a schedule-based DR program.

FIG. 2 illustrates the ramping deadline time, which is the time point at which the DR preparation period ends, or that is, the time point by which ramping is to be completed. If ramping in a demand response event is completed before the ramping deadline time, the demand response event is considered as being successful.

The ramping deadline time can be calculated as follows, for example.

ramping deadline time=DR commencement time+time length of DR preparation period

In a demand response event, the aggregator receives, from the electric utility, time information identifying the DR preparation period, based on which the ramping deadline time is specified. Note that the aggregator may receive, from the electric utility, timing information that directly identifies the ramping deadline time, rather than time information identifying the time length between the DR commencement time and the ramping deadline time.

In a demand response event based on an instruction-based DR program, the DR completion time is the time point when the electric utility transmits the DR termination signal to the aggregator. Meanwhile, in a demand response event based on a schedule-based DR program, the DR completion time is the time point identified by the DR completion time identifier, which is transmitted prior to the demand response event from the electric utility to the aggregator. Note that in a demand response event based on a schedule-based DR program, the DR completion time is not the time point when the DR completion time identifier is transmitted from the electric utility to the aggregator.

In a demand response event, the aggregator receives, from the electric utility, time information for specifying the DR completion time. In a demand response event based on an instruction-based DR program, the time information for specifying the DR completion time is the DR termination signal. In a demand response event based on a schedule-based DR program, the time information for specifying the DR completion time is the DR completion time identifier.

In FIG. 2, ramping is started at the DR commencement time. However, it should be noted that by delaying the commencement of ramping with respect to the DR commencement time while ensuring that ramping is still completed within the DR preparation period, the DR period in a demand response event can be shortened. Shortening the DR period results in DR cancellation being performed less frequently.

The following explains embodiments of the present invention, which are based on such findings.

### Embodiment 1

Embodiment 1 focuses on a demand response event that is based on a DR program specifying the DR commencement time of the demand response event, the DR completion time of the demand response event, and the DR preparation period of the demand response event. In such a demand response event, ramping needs to be completed before the end of the DR preparation period. When ramping is completed before the end of the DR preparation period, and if changed load is maintained until the DR completion time without the occurrence of DR cancellation, an aggregator receives a payment of an incentive from an electric utility. On the other hand, when ramping is not completed before the end of the DR preparation period, the aggregator pays a penalty to the electric utility.

Embodiment 1 describes a DR system in which a DR service purchaser exists. The DR service purchaser purchases a service (referred to in the following as a DR service) of reducing the amount of electricity demanded by at least one demander (i.e., the amount of electricity consumed by the demander) through execution of a demand response event. For example, the DR service purchaser may be an electric utility or an electricity market. Description in embodiment 1 is based on a case where an electric utility is the DR service purchaser. The electric utility determines the DR commencement time, the DR preparation period, and the DR completion time in the DR program. In addition, the electric utility also determines the incentive and the penalty. The electric utility notifies the aggregator of such information.

In addition to the DR service purchaser (the electric utility), the DR system in embodiment 1 includes the aggregator. The aggregator sells the DR service to the electric utility and controls at least one load resource possessed by the demander to accomplish the DR service. The aggregator obtains load related data from the demander, who participates in the DR program. The load-related data is related to the load resource that the demander possesses. The load-related data includes information related to the load resource, such as ramping performance information, context information, baseline information, and a desired load of the load resource in a demand response event. The ramping performance information is necessary for calculating a time length required for the load resource to ramp up/down, and may include, for example, a load change range of the load resource and/or characteristics of the load resource related to time required for changing load. The context information indicates a “context” of the load resource, which in the present disclosure refers to circumstances surrounding the load resource and the values of settings made to the load resource. For example, when the load resource is an air conditioner, the “context” of the load resource includes outdoor temperature, weather, and temperature setting. The baseline information indicates a baseline load of the load resource, which is an estimated load value of the load resource when not participating in demand response events. The baseline information is used to determine the change in load of the load resource in a demand response event.

The demander, who participates in demand response, may perform DR cancellation if aggregator control in a demand response event reduces the functionality of the load resource.

In embodiment 1, the aggregator determines ramping commencement time. The ramping commencement time is defined as a time point in a demand response event at which the load resource possessed by the demander actually commences ramping. That is, in embodiment 1, the aggregator does not cause the load resource to commence ramping at the DR commencement time, which is determined by the electric utility having entered a DR contract with the aggregator. Instead, the aggregator causes the load resource to commence ramping at the ramping commencement time, which is later (i.e., delayed) than the DR commencement time. As such, the commencement of ramping is delayed with respect to the DR commencement time. Further, it should be noted that the commencement of ramping is delayed not only due to communication-related delay, calculation-related delay, etc., but also due to delay that is added intentionally.

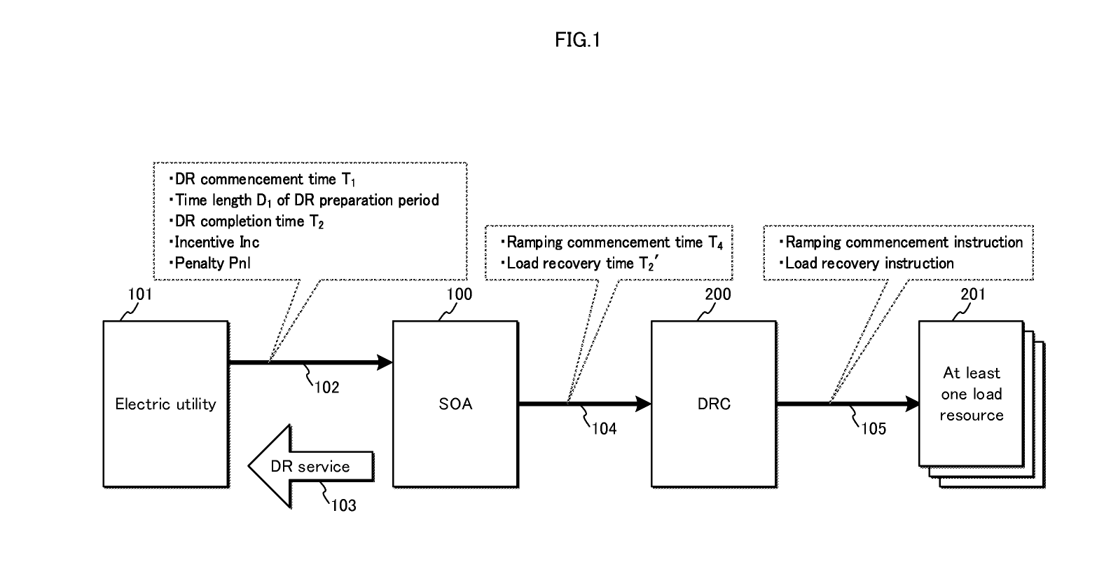

FIG. 1 illustrates one example of the structure of the DR system in embodiment 1. The DR system in embodiment 1 includes the electric utility (indicated by reference sign 101), a server belonging to the aggregator (referred to in the following and in the drawings as “SOA” and indicated by reference sign 100), a demand response controller (referred to in the following and in the drawings as “DRC” and indicated by reference sign 200), and at least one load resource possessed by the demander (indicated by reference sign 201).

The electric utility 101 determines the DR commencement time of a demand response event (one example of which being DR commencement time T₁), a time length of the DR preparation period of the demand response event (one example of which being the time length D₁), the DR completion time of the demand response event (one example of which being DR completion time T₂), the incentive (one example of which being incentive Inc), and the penalty (one example of which being penalty Pnl). The electric utility 101 notifies the SOA 100 of the information so determined via a communication tool 102.

The SOA 100, based on the information notified from the electric utility 101, calculates the ramping deadline time in the demand response event (one example of which being ramping deadline time T₃), and determines the ramping commencement time in the demand response event (one example of which being ramping commencement time T₄) and the load recovery time in the demand response event (one example of which being load recovery time T₂′). Note that the load recovery time (T₂′) is a time point in the demand response event at which a recovery process of reverting the load of the load resource 201, having been changed through ramping, to a pre-ramping level is commenced. In embodiment 1, the load recovery time (T₂′) equals the DR completion time (T₂). However, the load recovery time and the DR completion time need not be equal. The SOA 100 notifies the DRC 200 of the ramping commencement time and the load recovery time via a communication tool 104.

Note that in FIG. 1, the arrow 103 extending from the SOA 100 to the electric utility 101 indicates that the SOA 100 sells a DR service to the electric utility 101 and that the electric utility 101 is the DR service purchaser.

The DRC 200 controls the load resource 201 based on the ramping commencement time (T₄) and the load recovery time (T₂′) notified from the SOA 100. In specific, the DRC 200 transmits a ramping commencement instruction and a load recovery instruction to the load resource 201 via a communication tool 105. The ramping commencement instruction causes the load resource 201 to commence ramping at the ramping commencement time (T₄). The load recovery instruction causes the load resource 201 to commence the recovery process at a time point no earlier than the load recovery time (T₂′).

The ramping commencement instruction may include time information for specifying the ramping commencement time (T₄), in which case the load resource 201 may specify the ramping commencement time (T₄) from this time information and thereby commence the ramping at the ramping commencement time (T₄). Alternatively, the ramping commencement instruction may not include the time information for specifying the ramping commencement time (T₄), in which case the load resource 201 may commence ramping at the same time as receiving the ramping commencement instruction.

Note that the electric utility 101 may include the SOA 100. That is, the electric utility 101 may have the functions of the SOA 100 and may communicate directly with the DRC 200 without the SOA 100 in between. Further, the SOA 100 may include the DRC 200. That is, the SOA 100 may have the functions of the DRC 200 and may communicate directly with the load resource 201 without the DRC 200 in between.

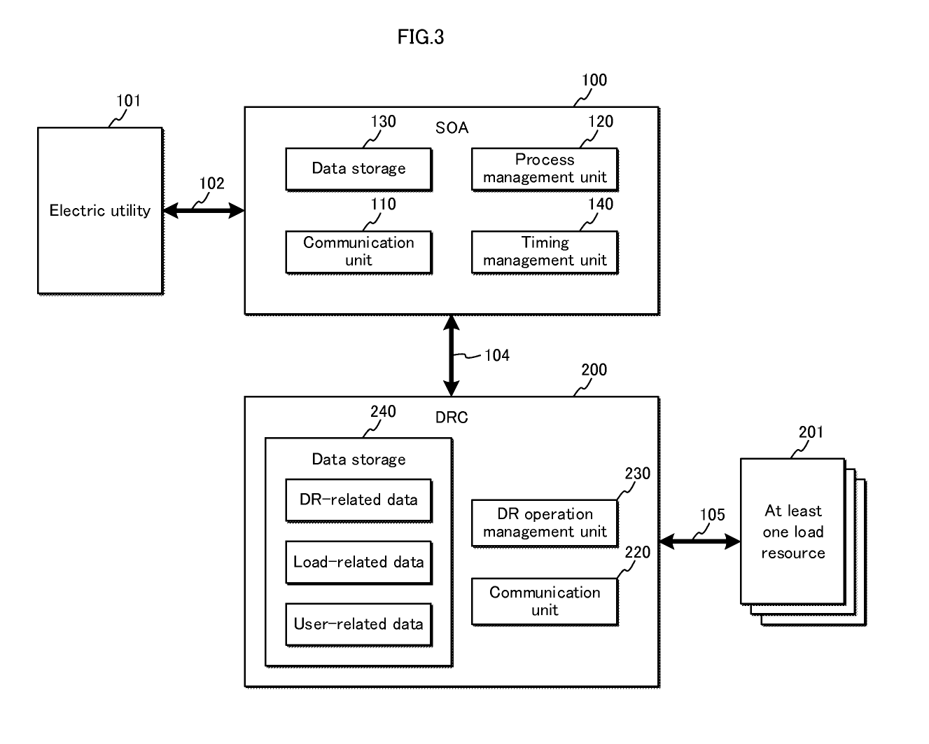

FIG. 3 is a block diagram illustrating the functional structures of the SOA 100 and DRC 200 in embodiment 1.

As illustrated in FIG. 3, the SOA 100 includes a communication unit 110, a process management unit 102, a data storage 130, and a timing management unit 140.

The communication unit 110 receives time information (for example, time information specifying the DR commencement time (T₁), the time length (D₁) of the DR preparation period, and the DR completion time (T₂)) from the electric utility 101 via the communication tool 102. In addition, the communication unit 110 transmits time information (for example, time information for specifying the ramping commencement time (T₄) and the load recovery time (T₂′) (the DR completion time (T₂)) to the DRC 200 via the communication tool 104.

The process management unit 102 performs, for example, specification of the DRC 200, which is connected with the SOA 100, generation of signals to be transmitted to the DRC 200, and management of data.

The timing management unit 140 manages ramping timing. In specific, the timing management unit 140 determines the ramping commencement time (T₄) to be transmitted to the DRC 200, and generates time information for specifying the ramping commencement time (T₄). In addition, the timing management unit 140 determines the load recovery time (T₂′), and generates time information for specifying the load recovery time (T₂′).

The data storage 130 stores data required in processing performed by the SOA 100. The data stored in the data storage 130 includes, for example, DR contract data (including, for example, the incentive (Inc), the penalty (Pnl), and the time length (D₁) of the DR preparation period), delay information (information on intrinsic delay τ_{Intrinsic}, which is described later in the present disclosure), and information notified from the DRC 200 (load-related data and user-related data).

As illustrated in FIG. 3, the DRC 200 includes a communication unit 220, a DR operation management unit 230, and a data storage 240.

The communication unit 220 receives time information (for example, the time information for specifying the ramping commencement time (T₄) and the time information for specifying the load recovery time (T₂′)) from the SOA 100 via the communication tool 104. In addition, the communication unit 220 transmits instructions (for example, the ramping commencement instruction and the load recovery instruction) to the load resource 201 via the communication tool 105.

The DR operation management unit 230 performs, for example, generation of instructions such as the ramping commencement instruction and the load recovery instruction, specification of the load resource 201, to which the instructions are to be transmitted, processing such as monitoring and correction of the load of the load resource 201 during the demand response event, and management of data.

The data storage 240 stores data related to the demand response event, the load-related data, and the user-related data. The load-related data and the user related data are described in detail later in the present disclosure.

Note that the above-described functional blocks of the SOA 100 are realized by a processor included in the SOA 100 executing one or more programs that are stored in a memory included in the SOA 100. Similarly, the above-described functional blocks of the DRC 200 are realized by a processor included in the DRC 200 executing one or more programs that are stored in a memory included in the DRC 200.

Each of the communication tools 102, 104, and 105 may be a wireless communication protocol such as Wi-Fi™, ZigBee™, or Bluetooth™, an interne connection, or a telephone line connection. Note that such forms of communication are mere examples, and other forms of communication are also applicable.

<Concept of Delaying Commencement of Ramping>

As already described above, the timing management unit 140 of the SOA 100 determines the ramping commencement time (T₄). Further, the SOA 100 instructs the DRC 200 to cause the load resource 201 to commence ramping so as to be delayed with respect to the DR commencement time (T₁), or more specifically, at the ramping commencement time (T₄), which is later than the DR commencement time (T₁). Thus, the load resource 201 commences ramping at the ramping commencement time (T₄), which is determined by the SOA 100, and not the DR commencement time (T₁), which his determined by the electric utility 101. Accordingly, the commencement of ramping can be delayed deliberately, and the DR period in the demand response event can be shortened.

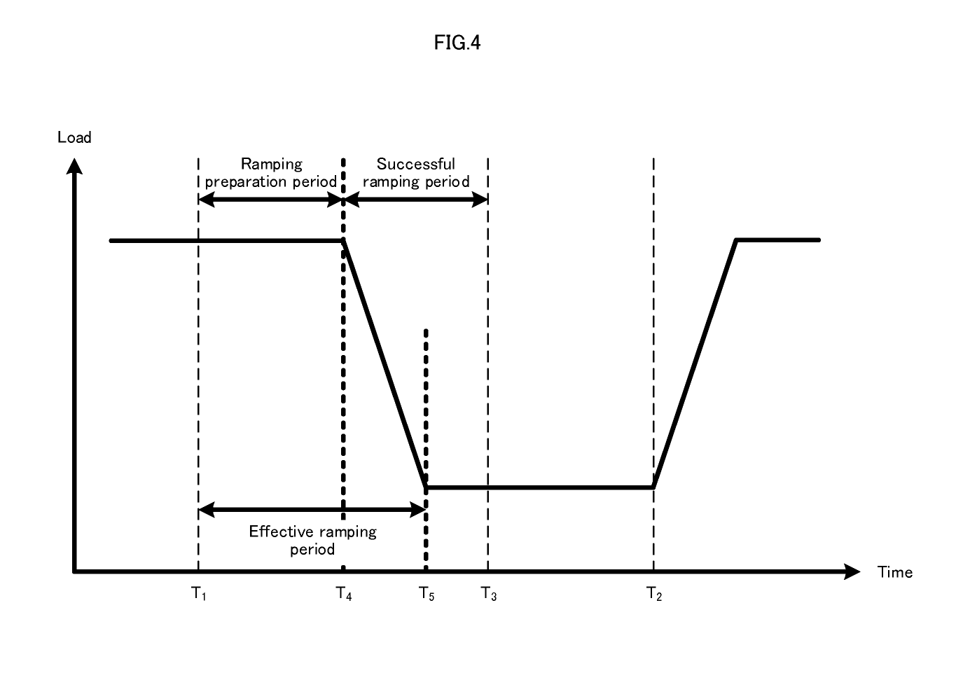

FIG. 4 illustrates one example of timing characteristics in a demand response event where the commencement of ramping is delayed. FIG. 4 illustrates a ramping preparation period, which is a time period from the DR commencement time (T₁) to the ramping commencement time (T₄). A time length of the ramping preparation period (one example of which being a time length D₂) can be expressed as follows.

D₂=T₄−T₁

FIG. 4 illustrates ramping completion time (one example of which being ramping completion time T₅), which is a time point at which ramping commenced by the load resource 201 at the ramping commencement time (T₄) is completed. The demand response event is considered as being successful when the following expression, which involves the ramping deadline time (T₃), holds true.

T₅<T₃

That is, in order for the demand response event to be considered successful, ramping by the load resource 201, whose commencement is delayed with respect to the DR commencement time (T₁) by the time length (D₂) of the ramping preparation period, needs to be completed within a successful ramping period, which is illustrated in FIG. 4. A time length of the successful ramping period (one example of which being a time length D₃) can be expressed as follows by using the ramping deadline time (T₃) and the ramping commencement time (T₄).

D₃=T₃−T₄

Further, FIG. 4 illustrates an effective ramping period, which is a time period from the DR commencement time (T₁) to the ramping completion time (T₅). A time length of the effective ramping period (one example of which being a time length D₄) can be expressed as follows.

D₄=T₅−T₁

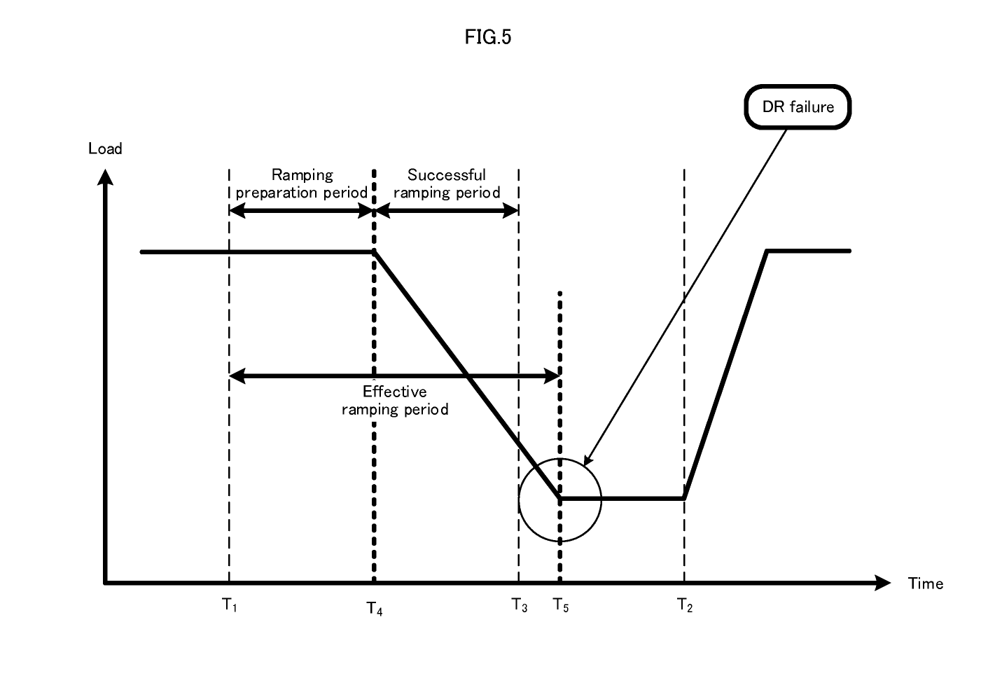

Here, it should be noted that when delaying the commencement of ramping with respect to the DR commencement time, the likelihood of ramping not being completed within the DR preparation period (i.e., the likelihood of DR failure) increases. FIG. 5 illustrates one example of timing characteristics in a demand response event where DR failure occurs. DR failure occurs, for example, when the effective ramping period is too long. DR failure occurs when the following expression holds true.

D₄>D₁=T₃−T₁

This expression can be rewritten as follows.

T₅>T₃

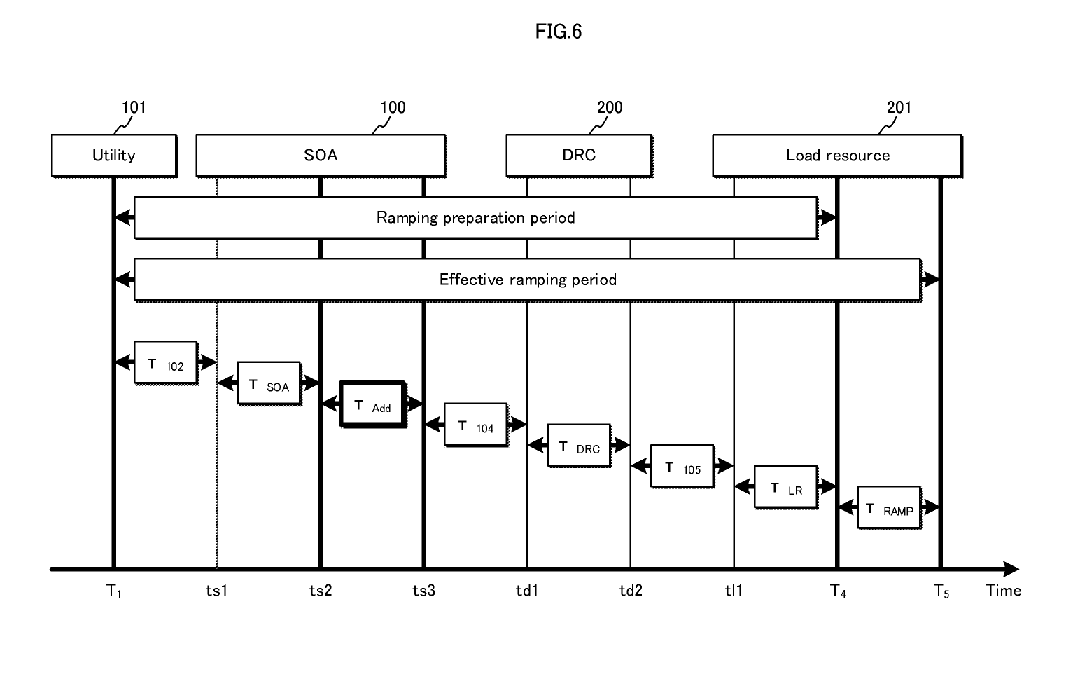

FIG. 6 illustrates one example of what constitutes the effective ramping period in embodiment 1. The effective ramping period is mainly constituted of three types of delay, namely the three following types (A), (B), and (C).

(A) Added Delay τ_{Add}

FIG. 6 illustrates added delay τ_{Add}. In specific, FIG. 6 illustrates an example where the added delay τ_{Add} is inserted between time points t_{S2} and t_{S3}. This added delay τ_{Add} is significant in embodiment 1. The added delay τ_{Add} does not derive from processing, communication, etc., by the SOA 100, the DRC 200, or the LR 201. Rather, the added delay τ_{Add} is added intentionally to extend the ramping preparation period.

(B) Intrinsic Delay τ_{Intrinsic}

FIG. 6 illustrates intrinsic delay τ_{Intrinsic} deriving from processing such as calculation, communication, etc., by the SOA 100, the DRC 200, and the LR 201. FIG. 6 illustrates the following as unlimiting examples of the intrinsic delay T_{Intrinsic}: delay τ₁₀₂, delay τ_{SOA}, delay τ₁₀₄, delay τ_{DRC}, delay τ₁₀₅, and delay τ_{LR}. The intrinsic delay τ_{Intrinsic} may include delay of types other than those illustrated in FIG. 6.

FIG. 6 illustrates delay τ₁₀₂ between time points T₁ and t_{S1}. Delay τ₁₀₂ is generated at the communication tool 102 when the electric utility 101 transmits, to the SOA 100, the time information for specifying the DR commencement time (T₁).

FIG. 6 illustrates delay τ_{SOA} between time points t_{S1} and t_{S2}. Delay τ_{SOA} corresponds to the time required by the SOA 100 to perform various types of processing. The processing performed by the SOA 100 includes: analysis of the time information for specifying the DR commencement time (T₁); determination of the ramping commencement time (T₄); and generation of the time information for specifying the ramping commencement time (T₄). Note that the time length of the delay τ_{SOA} is influenced by the processing speed of the SOA 100. Further, note that when the SOA 100 adds the added delay τ_{Add}, the added delay τ_{Add} is added so as to be separate from the delay τ_{SOA}.

FIG. 6 illustrates delay τ₁₀₄ between time points t_{S3} and t_{d1}. Delay τ₁₀₄ is generated at the communication tool 104 when the SOA 100 transmits, to the DRC 200, the time information for specifying the ramping commencement time (T₄).

FIG. 6 illustrates delay τ_{DRC} between time points t_{d1} and t_{d2}. Delay τ_{DRC} corresponds to the time required by the DRC 200 to perform various types of processing. The processing performed by the DRC 200 includes analysis of the time information for specifying the ramping commencement time (T₄) and generation of output signals to be transmitted to the load resource 201. Note that the time length of the delay τ_{DRC} is influenced by the processing speed of the DRC 200. Further, note that when the DRC 200 adds the added delay τ_{Add}, the added delay τ_{Add} is added so as to be separate from the delay τ_{DRC}.

FIG. 6 illustrates delay τ₁₀₅ between time periods t_{d2} and t₁₁. Delay τ₁₀₅ is generated at the communication tool 105 when the DRC 200 transmits the ramping commencement instruction to the load resource 201.

FIG. 6 illustrates delay τ_{LR} between time points t₁₁ and τ₄. Delay τ_{LR} corresponds to the time required by the load resource 201 to perform various types of processing. The processing performed by the load resource 201 includes analysis of the ramping commencement instruction and generation of data for ramping-related operations. Note that the time length of the delay τ_{LR} is influenced by the processing speed of the load resource 201. Further, note that when the load resource 201 adds the added delay τ_{Add}, the added delay τ_{Add} is added so as to be separate from the delay τ_{LR}.

(C) Ramping Delay τᵣₐₘₚ

FIG. 6 illustrates ramping delay τᵣₐₘₚ, which derives from the physical performance of the load resource 201, and is generated when the load resource 201 executes ramping according to the ramping commencement instruction received from the DRC 200. As illustrated in FIG. 6, the ramping delay τᵣₐₘₚ is a time period between the ramping commencement time (T₄) and the ramping completion time (T₅). Note that when the load resource 201 adds the added delay τ_{Add}, the added delay τ_{Add} is added so as to be separate from the ramping delay τᵣₐₘₚ.

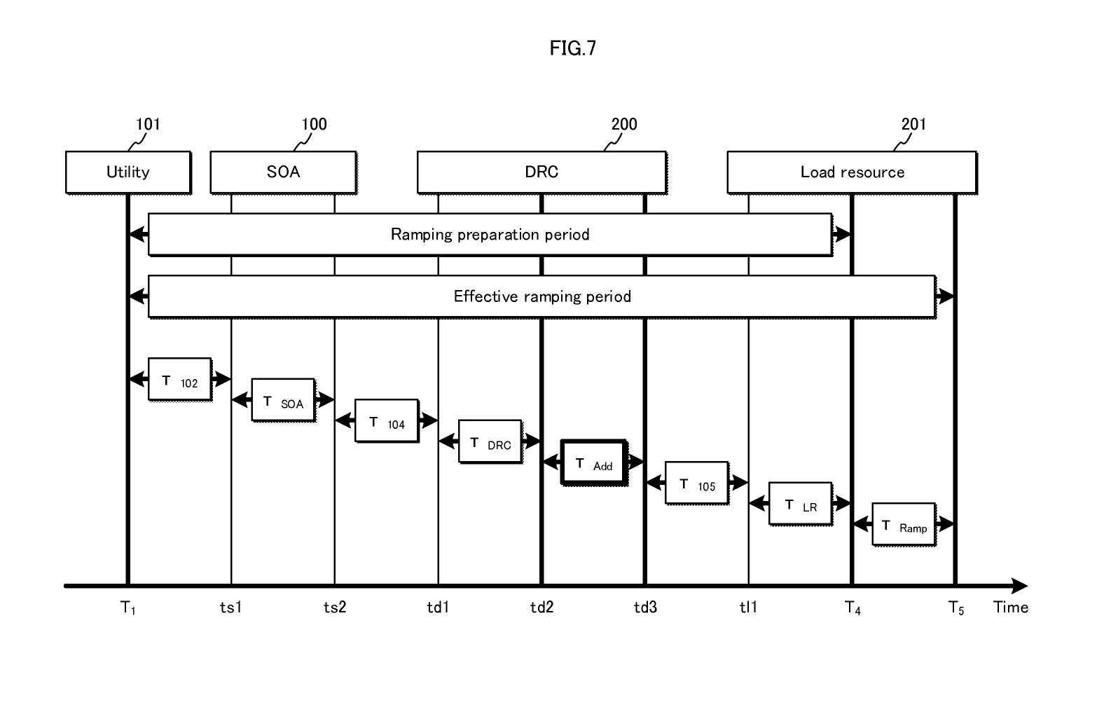

Here, it should be noted that the added delay τ_{Add} may be added by the DRC 200 and not the SOA 100, as illustrated in FIG. 7. FIG. 7 illustrates a modified example of what constitutes the effective ramping period. In this modified example, the SOA 100 does not add the added delay τ_{Add}, and requests, at time point t_{S2}, that the DRC 200 cause the load resource 201 to commence ramping. Note that t_{S2} can be expressed as follows.

t_{S2}=T₁+τ₁₀₂+τ_{SOA}

At some point later than time point t_{S2}, the DRC 200 adds the added delay τ_{Add}.

Alternatively, the added delay τ_{Add} may be added by the load resource 201, not the SOA 100 or the DRC 200. That is, the SOA 100 may request, at time point t₃₂ in FIGS. 6 and 7, that the DRC 200 cause the load resource 201 to commence ramping, the DRC 200 may instruct, at time point t_{d2} in FIG. 7, the load resource 201 to commence ramping, and the load resource 201 may add the added delay τ_{Add} before commencing ramping.

<Calculation of Optimal Time Length τₒₚₜ of Added Delay>

To shorten the DR period, or that is, to reduce the probability of DR cancellation, it is preferable to delay the commencement of ramping as much as possible. However, delaying the commencement of ramping results in DR failure occurring at an increased likelihood. The following describes how an optimal time length τₒₚₜ of the added delay τ_{Add} can be calculated while taking into consideration the trade-off relationship between the probability of DR failure and the probability of DR cancellation.

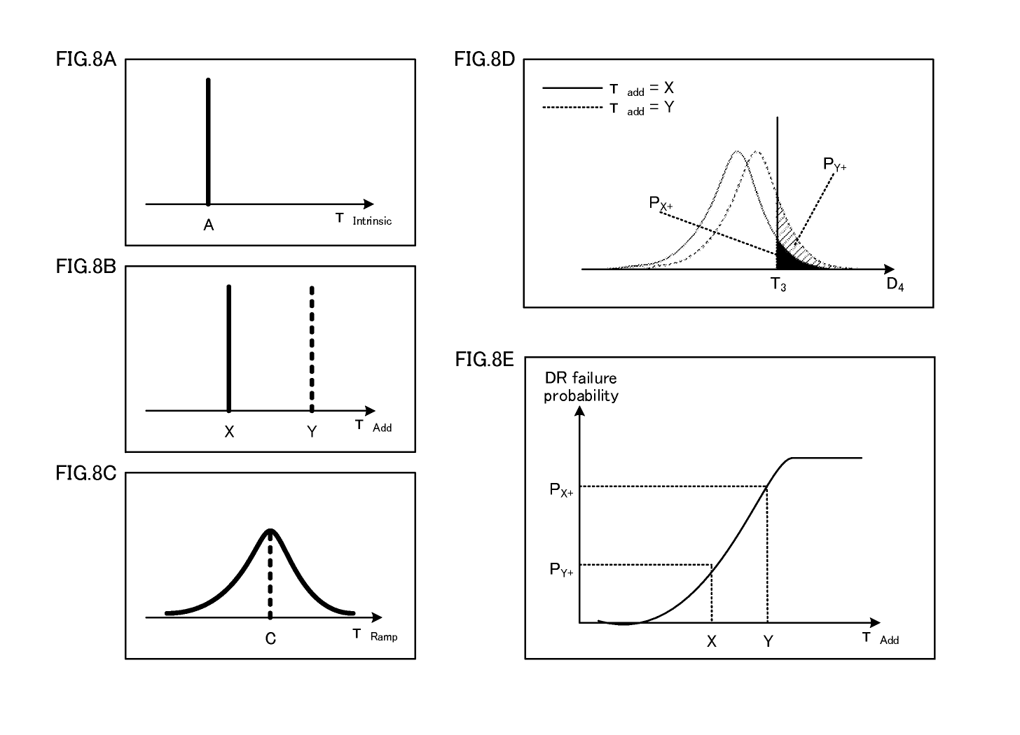

FIGS. 8A through 8E illustrate the relationship in embodiment 1 of the DR failure probability to the added delay τ_{Add}. FIG. 8A illustrates one example of a PDF of the intrinsic delay τ_{Intrinsic}. FIG. 8B illustrates one example of a PDF of the added delay τ_{Add}. In FIG. 8B, the solid line indicates the added delay τ_{Add} when having a time length of X seconds, whereas the broken line indicates the added delay τ_{Add} when having a time length of Y seconds (Y>X). FIG. 8C illustrates one example of a PDF of the ramping delay τ_{Ramp}.

In embodiment 1, the SOA 100 obtains estimated values (or data) of PDFs of the intrinsic delay τ_{Intrinsic} and the ramping delay τᵣₐₘₚ, and stores such information in the data storage 130. Alternatively, the DRC 200 may obtain such information and store such information in the data storage 240.

The SOA 100 calculates a PDF of the time length (D₄) of the effective ramping period by calculating a joint distribution of the PDFs illustrated in FIGS. 8A through 8C. FIG. 8D illustrates PDFs for different values of the time length (D₄) of the effective ramping period. As illustrated in FIG. 8D, the PDF of the time length (D₄) of the effective ramping period differs for different time lengths of the added delay τ_{Add}. When taking the PDFs illustrated in FIG. 8D as an example, the PDF located in the right corresponds to when the added delay τ_{Add} has a relatively long time length, whereas the PDF located in the left corresponds to when the added delay τ_{Add} has a relatively short time length. Note that FIG. 8D merely illustrates examples of PDFs of the time length (D₄) of the effective ramping period. That is, the PDFs illustrated in FIG. 8D are not based on actual calculation results.

Further, the SOA 100 calculates the DR failure probability based on the PDF of the time length (D₄) of the effective ramping period. In the PDF of the time length (D₄) of the effective ramping period, the area of the portion where the time length (D₄) of the effective ramping period is longer than the time length (D₁) of the DR preparation period indicates the DR failure probability. For example, the DR failure probability when the added delay τ_{Add} has the time length of X seconds (DR failure probability P_{X+}) corresponds to the area of the black portion in FIG. 8D, whereas the DR failure probability when the added delay τ_{Add} has the time length of Y seconds (DR failure probability P_{Y+}) corresponds to a total of the area of the hatched portion and the area of the black portion in FIG. 8D.

The SOA 100 calculates the DR failure probability for each possible time length of the added delay τ_{Add}. FIG. 8E illustrates one example of the DR failure probabilities calculated for possible time lengths of the added delay τ_{Add}. That is, FIG. 8E illustrates one example of the DR failure probabilities for different values set to the added delay τ_{Add}. As illustrated in FIG. 8E, the longer the time length of the added delay τ_{Add}, the greater the DR failure probability.

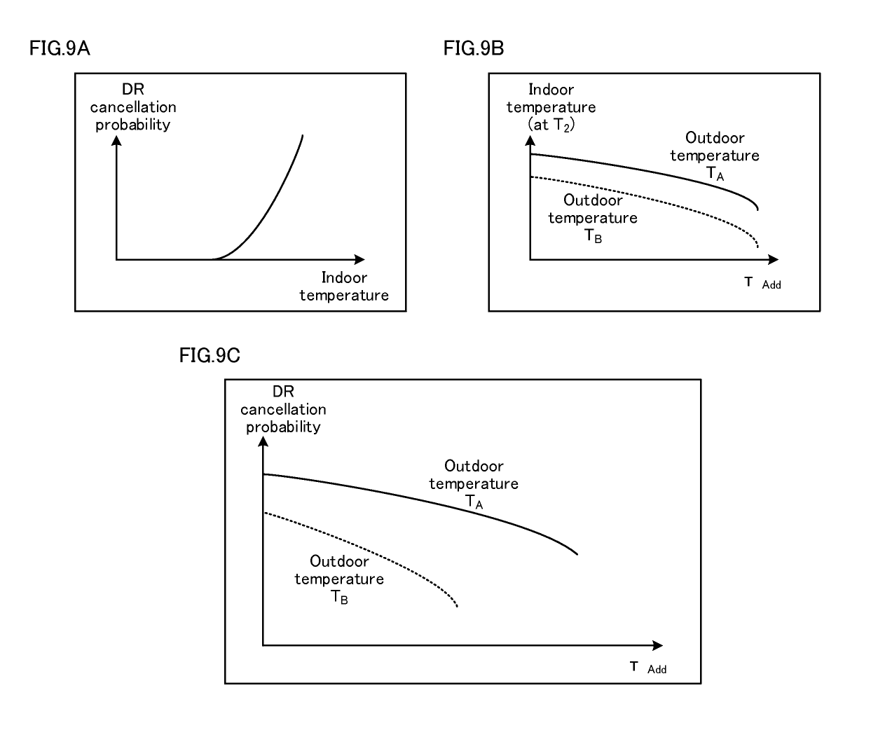

The following describes the relationship of the DR cancellation probability to the added delay τ_{Add}. FIGS. 9A through 9C illustrate the relationship of the DR cancellation probability to the added delay τ_{Add}. In the following, description is provided based on a case where the load resource 201 is an air conditioner and DR cancellation is performed if temperature becomes uncomfortable due to the air conditioner stopping as a result of demand response events.

FIG. 9A illustrates one example of the relationship of the DR cancellation probability to indoor temperature. FIG. 9A illustrates that the DR cancellation probability increases as indoor temperature rises.

FIG. 9B illustrates the relationship of indoor temperature upon completion of a demand response event to the added delay τ_{Add}. In specific, FIG. 9B illustrates the relationship between indoor temperature at the DR completion time (T₂) and the added delay τ_{Add}, for each of (i) a case where outdoor temperature is τ_{A} (illustrated by the solid line) and (ii) a case where outdoor temperature is τ_{B} (illustrated by the broken line). FIG. 9B illustrates that the longer the time length set to the added delay τ_{Add}, the smaller the rise in temperature resulting from the demand response event. Setting a longer time length to the added delay τ_{Add} suppresses the rise of temperature in such a manner because setting a longer time length to the added delay τ_{Add} results in a shorter DR period, or that is, the air conditioner staying in OFF state for a shorter time period.

In embodiment 1, the SOA 100 obtains the relationship of the DR cancellation probability to indoor temperature and the relationship of indoor temperature to the added delay τ_{Add}, and stores such information to the data storage 130. Alternatively, the DRC 200 may obtain such information and store such information in the data storage 240.

The SOA 100 calculates the relationship between the DR cancellation probability and the added delay τ_{Add} based on the information in FIGS. 9A and 9B, for example. FIG. 9C illustrates one example of the relationship so calculated. In specific, the SOA 100 calculates, for added delay τ_{Add} with a given time length, the indoor temperature at the DR completion time (T₂) based on FIG. 9B, for example. Further, the SOA 100 calculates the DR cancellation probability corresponding to the indoor temperature so calculated based on FIG. 9A, for example. A relationship such as that illustrated in FIG. 9C can be obtained by calculating the DR cancellation probabilities for different time lengths of the added delay τ_{Add}. FIG. 9C indicates that the longer the time length set to the added delay τ_{Add}, the lower the DR cancellation probability. Note that in FIG. 9C, the solid line indicates the case where outdoor temperature is T_{A}, and the broken line indicates the case where outdoor temperature is T_{B}.

FIGS. 9A through 9C are based on a case where the load resource is an air conditioner. However, the load resource may be an electrical device other than an air conditioner. The execution of a demand response event reduces load resource functionality regardless of what type of electric device the load resource may be. As such, regardless of what type of electric device the load resource may be, the DR cancellation probability decreases when the added delay τ_{Add} has a relatively long time length, or that is, the DR cancellation probability decreases for shorter DR periods. When the load resource is an electric device other than an air conditioner, the functionality of the electric device is to be taken into consideration, instead of indoor temperature. That is, when the load resource is an electric device other than an air conditioner, calculation is to be performed of (i) the degree by which reduction in load resource functionality can be suppressed by shortening the DR period, and (ii) the degree by which the DR cancellation probability can be reduced by suppressing reduction in load resource functionality.

One example of an electric device, other than an air conditioner, that may be the load resource is an electric power storage device that, in a demand response event, discharges power and thereby reduces the amount of electricity received from an electric grid. Such an electric power storage device benefits from a shortened DR period, as does an air conditioner. In specific, when the load resource is an electric power storage device, shortening the DR period results in the likelihood increasing of state of charge (SOC) of the electric power storage device being maintained at a high level at the DR completion time T₂. As such, when the load resource is an electric power storage device, the state of charge of the electric power storage device at the DR completion time (T₂) can be used as an indicator of functionality.

In the above, description has been provided on the effect that the shortening of the DR period has of reducing the DR cancellation probability. Examples of other effects that the shortening of the DR period may achieve include: improvement of customer satisfaction; reduction of welfare loss; increase in demand response participation rate; and increase in opportunities where a load resource can participate in demand response events.

For example, the following explains how opportunities where a load resource can participate in demand response events increase by shortening the DR period in demand response events.

(Case A)

For example, in case A, an air conditioner participates in a demand response event covering a thirty-minute period from 13:00 to 13:30. Further, in this demand response event, the ramping preparation period (D₂) is zero minutes. In this case, the DR period of the air conditioner is thirty minutes, and indoor temperature at 13:30 is high. As such, the air conditioner cannot participate in a demand response event covering the subsequent period from 13:30 to 14:00.

That is, in case A, the air conditioner can only participate in a demand response event during one of the two periods between 13:00 and 14:00.

(Case B)

For example, in case B, an air conditioner participates in a demand response event covering a thirty-minute period from 13:00 to 13:30. Further, in this demand response event, the ramping preparation period (D₂) is nine minutes. In this case, the DR period of the air conditioner is twenty one minutes, which is shorter than the DR period in case A by 30%. Due to this, indoor temperature at 13:30 is lower compared to that in case A. As such, the air conditioner may be able to participate in a demand response event covering the subsequent period from 13:30 to 14:00. Further, if the ramping preparation period is also nine minutes in the demand response event covering the subsequent period from 13:30 to 14:00, the air conditioner would cool the room from 13:30 to 13:39. As such, the air conditioner is able to participate in the demand response during the subsequent period from 13:30 to 14:00.

That is, in case B, the air conditioner is able to participate in demand response events during both of the two periods between 13:00 and 14:00.

As such, the SOA 100 can achieve the effect of increasing opportunities where a load resource is able to participate in demand response events by setting the added delay τ_{Add}.

In embodiment 1, the SOA 100 calculates an optimal time length τₒₚₜ of the added delay τ_{Add}, taking such effects into consideration. That is, the SOA 100 calculates an optimal time length τₒₚₜ that maximizes a predetermined objective function.

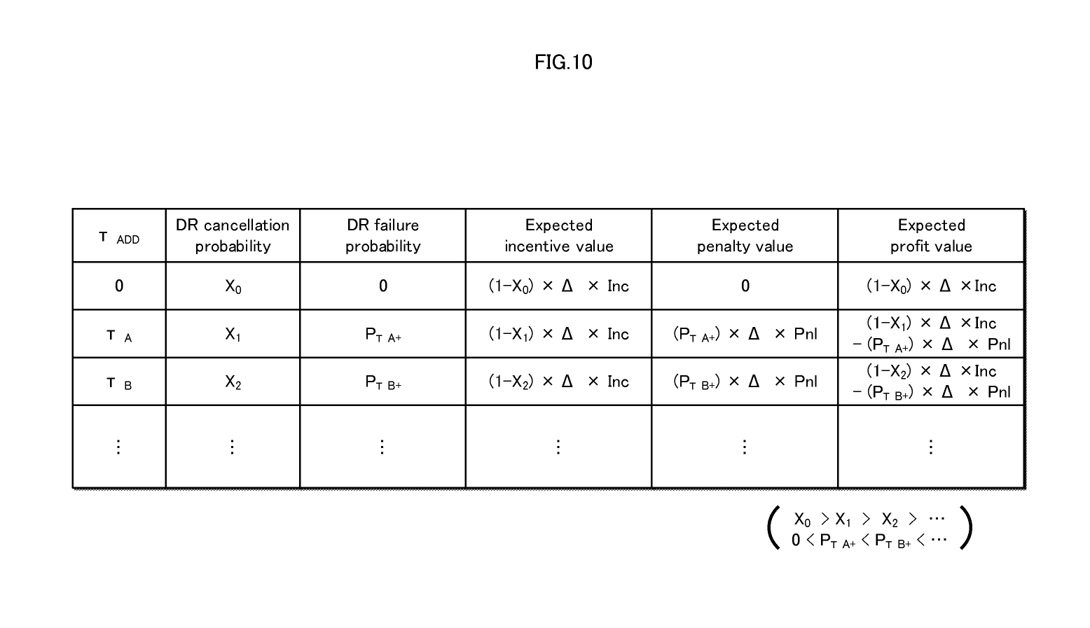

FIG. 10 illustrates one example of an objective function for calculating the profit of SOA 100 expected for different time lengths of the added delay τ_{Add}. The SOA 100 calculates, for each of such time lengths, an expected profit value by taking into consideration an expected value of the incentive that the SOA 100 would receive and an expected value of the penalty that the SOA 100 would need to pay. Note that in FIG. 10, the symbol “Δ” indicates an amount of load change brought about by ramping in a demand response event, “Inc” indicates incentive per unit load change amount, and “Pnl” indicates penalty per unit load change amount. Note that in embodiment 1, description is provided based on a case where the SOA 100 determines the load change amount Δ and notifies the DRC 200 of the load change amount Δ, the DRC 200 generates an instruction signal including the load change amount Δ and notifies the load resource 201 of the instruction signal, and the load resource 201 performs ramping so that the load change amount Δ is achieved.

The following explains how the expected profit value is calculated. For example, say the DR cancellation probability is X₀ and the DR failure probability is zero when time length zero is set to the added delay τ_{Add}. Then, the expected incentive value when time length zero is set to the added delay τ_{Add} is (1−X₀)×Δ×Inc, and the expected penalty value when time length zero is set to the added delay τ_{Add} is zero. Accordingly, the expected profit value when time length zero is set to the added delay τ_{Add} is (1−X₀)×Δ×Inc−0=(1−X₀)×Δ×Inc. Further, say the DR cancellation probability is X₁ (X₁<X₀) and the DR failure probability is Pτ_{A+} (Pτ_{A+}>0) when time length τ_{A} (τ_{A}>0) is set to the added delay τ_{Add}. Then, the expected incentive value when time length Pτ_{A+} is set to the added delay τ_{Add} is (1−X₁)×Δ×Inc−(Pτ_{A+})×Δ×Pnl. In a similar manner, the SOA 100 calculates the expected profit value for each time length of the added delay τ_{Add}. Further, the SOA 100 determines, as the optimal time length τₒₚₜ of the added delay τ_{Add}, the time length yielding the highest expected profit value.

Needless to say, the method described above is a mere example for ease of understanding. That is, other methods for optimizing the added delay τ_{Add} may be adopted, taking into consideration other market structures involving penalty and incentive and other constraints. That is, the SOA 100 may determine the optimal time length τₒₚₜ of the added delay τ_{Add} by optimizing an objective function other than the one described above. Examples of other objective functions usable for determining the optimal time length τₒₚₜ include that for maximizing customer satisfaction and that for minimizing DR cancellation.

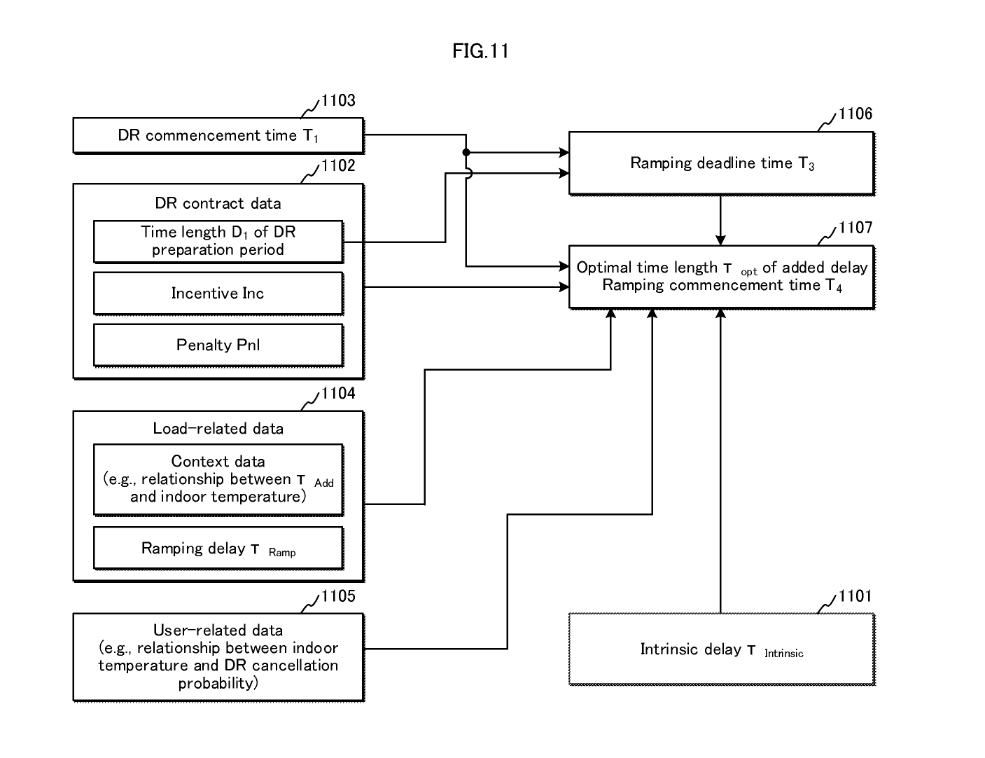

FIG. 11 illustrates information that is necessary for determining the optimal time length τₒₚₜ for the added delay τ_{Add} in embodiment 1.

Reference sign 1101 in FIG. 11 indicates the PDF of the intrinsic delay τ_{Intrinsic}. The SOA 100 obtains the PDF 1101 of the intrinsic delay τ_{Intrinsic}, through communication with the electric utility 101, the DRC 200, and the load resource 201. The SOA 100 may perform calculation or estimation for obtaining the PDF 1101, or may receive the PDF 1101.

Reference sign 1102 in FIG. 11 indicates the DR contract data (including the time length (D₁) of the DR preparation period, the incentive (Inc), the penalty (Pnl), etc.,) and reference sign 1103 in FIG. 11 indicates the DR commencement time (T₁). The SOA 100 obtains the DR contract data 1102 and the DR commencement time (T₁) 1103 from the electric utility 101. Note that the SOA 100 may obtain the DR contract data 1102 and the DR commencement time (T₁) 1103 at the same time point or at different time points.

Reference sign 1104 in FIG. 11 indicates the load-related data. The load-related data 1104 includes the context information (e.g., the relationship of indoor temperature at the DR completion time (T₂) to the added delay τ_{Add}, outdoor temperature, etc.,) and the PDF of the ramping delay τ_{Ramp}. In embodiment 1, the SOA 100 obtains the load-related data 1104 from the DRC 200. Alternatively, the SOA 100 may obtain the load-related data 1104 from the load resource 201, or may obtain or estimate the load-related data 1104 from, for example, data of demand response events executed in the past.

Reference sign 1105 in FIG. 11 indicates the user-related data (e.g., relationship of the DR cancellation probability to indoor temperature, etc.,). In embodiment 1, the SOA 100 obtains the user-related data 1105 from the DRC 200. Alternatively, the SOA 100 may obtain the user-related data 1104 from the load resource 201, or may obtain or estimate the user-related data 1104 from DR cancellation history. Here, the DR cancellation history is, for example, information indicating whether or not the demander has performed DR cancellation in past demand response events, in association with the context of the load resource 201 when such past demand response events were executed.

Reference sign 1106 indicates the ramping deadline time (T₄). In embodiment 1, the timing management unit 140 of the SOA 100 calculates the ramping deadline time (T₄) 1106 based on the DR commencement time (T₁) 1103 and the time length (D₁) of the DR preparation period, which is included in the DR contract data 1102.

The timing management unit 140 of the SOA 100 calculates the optimal time period τₒₚₜ 1107 when obtaining information 1101 through 1106 described above.

Note that, when the DRC 200 and/or the load resource 201 exist in plurality, the SOA 100 may calculate an optimal time period τₒₚₜ of the added delay τ_{Add} for each of the DRCs 200 and/or the load resources 201.

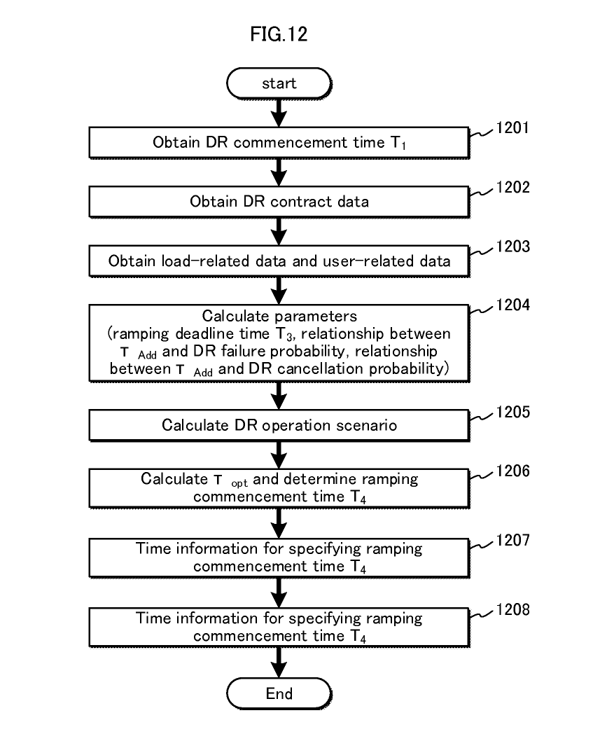

FIG. 12 is a flowchart illustrating the operations of the SOA 100 in embodiment 1.

As illustrated in FIG. 12, the operations of the SOA 100 in embodiment 1 include: a step of obtaining the time information for specifying the DR commencement time (T₁) (1201); a step of obtaining the DR contract data (including the incentive (Inc), the penalty (Pnl), and the time length (D₁) of the DR preparation period) (1202); and a step of obtaining the load-related data and the user-related data (1203).

The operations of the SOA 100 in embodiment 1 further include: a step of calculating parameters (including, for example, the ramping deadline time (T₃), the relationship between the added delay τ_{Add} and the DR failure probability, and relationship between the added delay τ_{Add} and the DR cancellation probability) based on the information so obtained (1204); a step of determining a DR operation scenario (i.e., calculating the expected profit value for each time length of the added delay τ_{Add}) (1205); and a step of determining the optimal time period τₒₚₜ of the added delay τ_{Add} and the ramping commencement time (T₄) (1206).

In addition, the operations of the SOA 100 in embodiment 1 further include: a step of generating the time information for specifying the ramping commencement time (T₄) (1207); and a step of transmitting the time information for specifying the ramping commencement time (T₄) to the DRC 200, so that ramping is commenced at the ramping commencement time (T₄) so determined (1208).

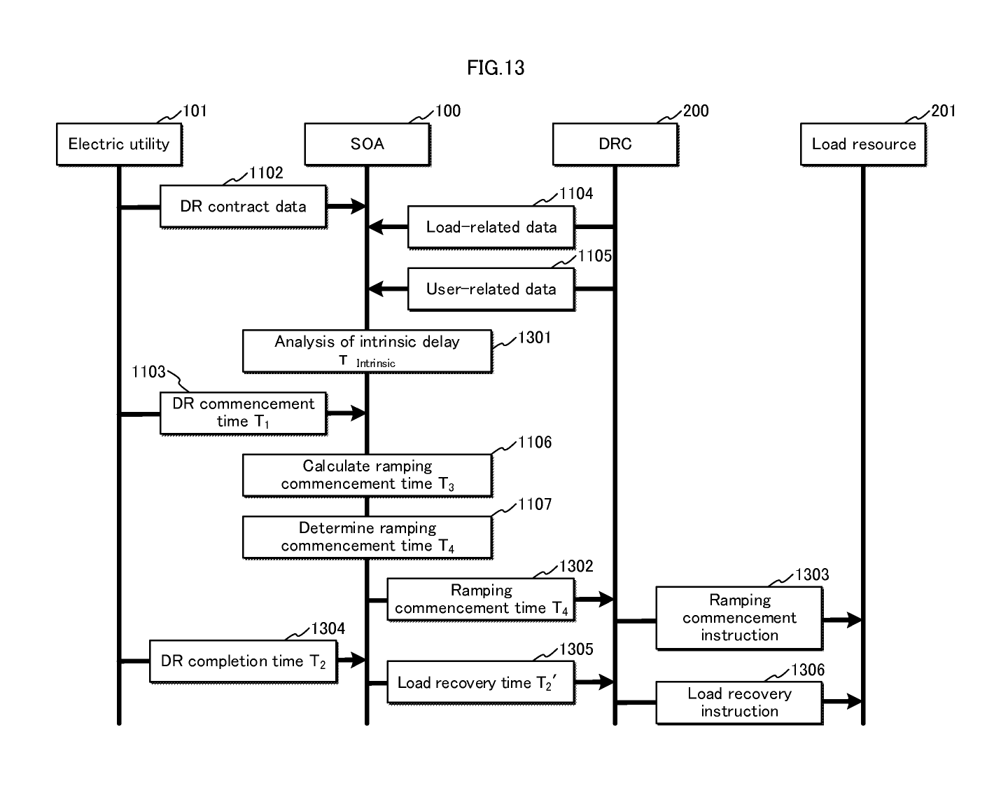

FIG. 13 is a sequence diagram of the DR system in embodiment 1. Note that in FIG. 13, information already illustrated in FIG. 11 is indicated by using the same reference signs. Further, description on such information is not provided in the following.

The SOA 100 calculates, updates, or receives the PDF of the intrinsic delay τ_{Intrinsic}, based on communication with, for example, the electric utility 101 and the DRC 200.

The SOA 100, after calculating the ramping commencement time (T₄), generates the time information for specifying the ramping commencement time (T₄) so calculated and transmits the time information to the DRC 200 (1302).

The DRC 200 generates the ramping commencement instruction based on the time information received from the SOA 100 and transmits the ramping commencement instruction to the load resource 201 (1303). The load resource 201, when receiving the ramping commencement instruction, commences ramping.

Following this, the SOA 100, when receiving the time information for specifying the DR completion time (T₂) from the electric utility 101 (1304), determines the load recovery time (T₂′), and transmits the time information for specifying the load recovery time (T₂′) to the DRC 200 (1305).

The DRC 200 generates the load recovery instruction based on the time information received from the SOA 100 and transmits the load recovery instruction to the load resource 201 (1306). The load resource 201, when receiving the load recovery instruction, terminates the demand response event.

This concludes the description based on FIG. 13, which illustrates how the DR system in embodiment 1 operates.

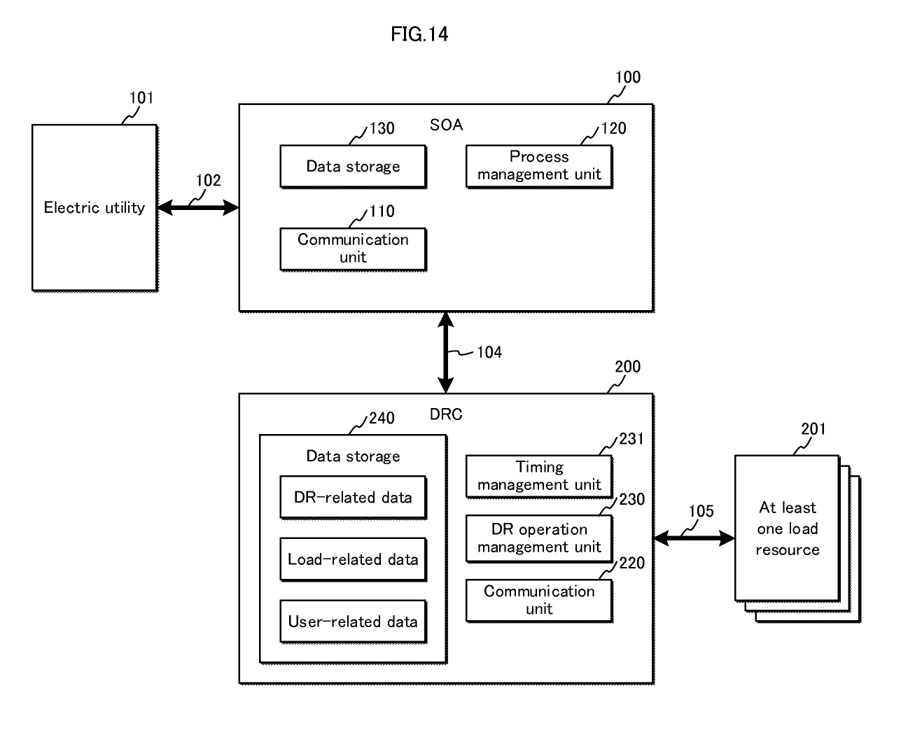

In the above, description is provided that the SOA 100 determines the ramping commencement time (T₄). Alternatively, the DRC 200 may determine ramping commencement time (T₄). FIG. 14 illustrates the functional structures of the SOA 100 and the DRC 200 in a modification where the DRC 200, and not the SOA 100, determines the ramping commencement time (T₄). In this modification, the SOA 100 does not include the timing management unit 140. Instead, the DRC 200 includes a timing management unit 231. The timing management unit 231 determines the ramping commencement time (T₄) and generates the time information for specifying the ramping commencement time (T₄). In specific, the timing management unit 231 of the DRC 200, when obtaining the DR contract data 1102 (or at least the ramping deadline time T₃ included in the DR contract data 1102), the DR commencement time (T₁) 1103, the load-related data 1104, the user-related data 1105, and the PDF 1101 of the intrinsic delay τ_{Intrinsic}, determines the ramping commencement time (T₄).

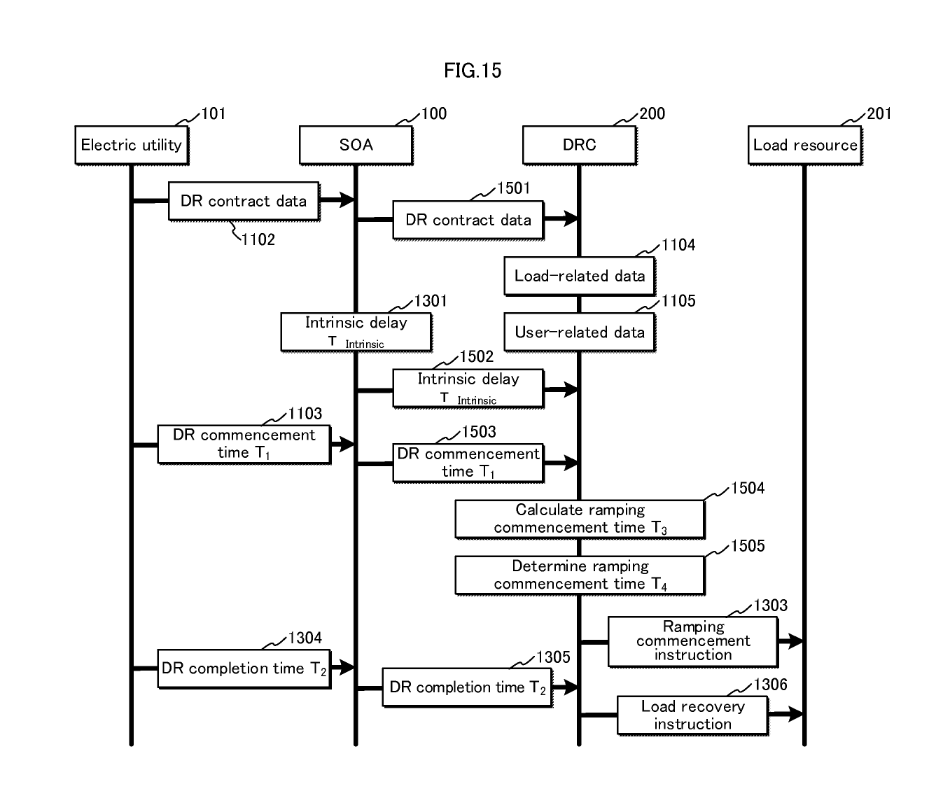

FIG. 15 is a sequence diagram of the DR system in the modification where the DRC 200, and not the SOA 100, determines the ramping commencement time (T₄). Note that in FIG. 14, information already illustrated in FIG. 13 is indicated by using the same reference signs. Further, description on such information is not provided in the following.

The SOA 100, when receiving the DR contract data 1102 from the electric utility 101, transmits the DR contract data 1102 (or at least the time length (D₁) of the DR preparation period included in the DR contract data 1102) to the DRC 200 (1501).

The SOA 100, when having calculated (or obtained) the PDF 1101 of the intrinsic delay τ_{Intrinsic}, transmits the intrinsic delay τ_{Intrinsic} so calculated to the DRC 200 (1502).

The SOA 100, when receiving the time information for specifying the DR commencement time (T₁) from the electric utility 101, transmits the time information so received to the DRC 200 (1503).

The DRC 200 calculates the ramping deadline time (T₃) by using the time length (D₁) of the DR preparation period, which is received in 1501, and the DR commencement time (T₁), which is received in 1503 (1504).

Then, the DRC 200 determines the optimal time length τₒₚₜ for the added delay τ_{Add} and the ramping commencement time (T₄) by using information that is available (including 1104, 1105, and 1501 through 1504) (1505).

This concludes the description based on FIG. 15, which illustrates how the DR system in embodiment 1 operates.

### Embodiment 2

Embodiment 2 discloses a DR system in which the incentive that the electric utility 101 pays to the SOA 100 changes depending upon the time length (D₄) of the effective ramping period. For example, the shorter the time length (D₄) of the effective ramping period, the higher the incentive paid to the SOA 100. Accordingly, in embodiment 2, information on incentive that changes depending upon the time length (D₄) of the effective ramping period is available for the SOA 100 to use. The SOA 100, by using this information, determines the ramping commencement time (T₄) that is most suitable for the load resource 201.

In embodiment 2, the electric utility 101 provides the information on the incentive that changes depending upon the time length (D₄) of the effective ramping period, without providing the time information for specifying the time length (D₁) of the DR preparation period. Accordingly, in embodiment 2, the SOA 100 need not pay a penalty in any case, because there is no need to cause ramping to be completed within a predetermined DR preparation period. However, due to the incentive to be received from the electric utility 101 changing depending upon the time length (D₄) of the effective ramping period, the amount of incentive that the SOA 100 receives decreases when the commencement of ramping is delayed.

Meanwhile, as already described above, delaying the commencement of ramping results in the DR period having a shorter time length, and the consequent reduction in DR cancellation probability. A reduction in DR cancellation probability results in a higher probability of an incentive being paid to the SOA 100.

As such, by using an objective function for maximizing profit that involves the incentive that changes depending upon the time length (D₄) of the effective ramping period, an optimal ramping commencement time (T₄) similar as that in embodiment 1 can be determined.

### (Supplement)

The following describes various aspects of the present invention.

(1) Aspect 1 of the present invention is a load control method for controlling a load connected to an electricity grid, the load control method including: obtaining first time information for specifying demand response commencement time and second time information for specifying ramping completion time, the demand response commencement time being a time point at which a demand response event is to be commenced, the ramping completion time being a time point at which ramping in the demand response event is to be completed and being later than the demand response commencement time, the ramping being a process through which an amount of electricity received from the electricity grid is changed; determining ramping commencement time based on the first time information and the second time information, the ramping commencement time being a time point at which the ramping is to be commenced, being later than the demand response commencement time, and being earlier than the ramping completion time; and causing the ramping to be commenced at the ramping commencement time.

According to this aspect of the present invention, the commencement of the ramping is delayed with respect to the commencement of the demand response event. Consequently, the time period during which the load resource operates at a changed load is shortened. Accordingly, this aspect of the present invention suppresses reduction in functionality of a load resource brought about by demand response.

(2) Aspect 2 of the present invention is the load control method of aspect 1, wherein in the determining, the ramping commencement time is determined by using a probability of the ramping being completed before the ramping completion time when the commencement of the ramping is delayed with respect to the demand response commencement time, the probability being calculated by using the first time information and the second time information.

According to this, control of a load resource can be performed such that ramping is completed earlier than a ramping deadline time.

(3) Aspect 3 of the present invention is the load control method of aspect 1, wherein in the determining, the ramping commencement time is determined by using a probability of the demand response event being cancelled when the commencement of the ramping is delayed with respect to the demand response commencement time, the probability being calculated by using the first time information and the second time information.

According to this, control of a load resource can be performed such that a demander shall not cancel a demand response event.

(4) Aspect 4 of the present invention is the load control method of aspect 1, wherein in the determining, the ramping commencement time is determined by using a first probability and a second probability that are calculated by using the first time information and the second time information, the first probability being a probability of the ramping being completed before the ramping completion time when the commencement of the ramping is delayed with respect to the demand response commencement time, and the second probability being a probability of the demand response event being cancelled when the commencement of the ramping is delayed with respect to the demand response commencement time.

According to this, control of a load resource can be performed such that ramping is completed earlier than a ramping deadline time and such that a demander shall not cancel a demand response event.

(5) Aspect 5 of the present invention is the load control method of aspect 2, wherein in the obtaining, characteristic information is obtained in addition to the first time information and the second time information, the characteristic information including at least one of characteristics of delay deriving from a communication network for transmitting a control signal for causing the ramping to be commenced and characteristics of time between the commencement and the completion of the ramping, and in the determining, the probability is calculated by using the characteristic information in addition to the first time information and the second time information.

(6) Aspect 6 of the present invention is the load control method of aspect 3, wherein in the obtaining, characteristic information is obtained in addition to the first time information and the second time information, the characteristic information including information on current settings of the load and characteristics of a relationship between settings of the load and demand response events cancelled in the past, and in the determining, the probability is calculated by using the characteristic information in addition to the first time information and the second time information.

(7) Aspect 7 of the present invention is the load control method of aspect 1, wherein in the obtaining, the first time information is obtained from an electric utility.

(8) Aspect 8 of the present invention is the load control method of aspect 1, wherein in the obtaining, the second time information is obtained from an electric utility.

(9) Aspect 9 of the present invention is the load control method of aspect 1, wherein in the obtaining, third time information for specifying demand response completion time is obtained in addition to the first time information and the second time information, the demand response completion time being a time point at which the demand response event is to be completed. The load control method of aspect 9 further includes causing the load to commence a recovery process after the demand response event is completed.

(10) Aspect 10 of the present invention is a load control device for controlling a load connected to an electricity grid, the load control device including: an obtaining unit obtaining first time information for specifying demand response commencement time and second time information for specifying ramping completion time, the demand response commencement time being a time point at which a demand response event is to be commenced, the ramping completion time being a time point at which ramping in the demand response event is to be completed and being later than the demand response commencement time, the ramping being a process through which an amount of electricity received from the electricity grid is changed; and a determining unit determining ramping commencement time based on the first time information and the second time information, the ramping commencement time being a time point at which the ramping is to be commenced, being later than the demand response commencement time, and being earlier than the ramping completion time. The load control device causes the ramping to be commenced at the ramping commencement time.

According to this aspect of the present invention, the commencement of the ramping is delayed with respect to the commencement of the demand response event. Consequently, the time period during which the load resource operates at a changed load is shortened. Accordingly, this aspect of the present invention suppresses reduction in functionality of a load resource brought about by demand response.

(11) Aspect 11 of the present invention is an electric load device including: a reception unit receiving a ramping commencement instruction being an instruction causing ramping in a demand response event to be commenced, the ramping being a process through which an amount of electricity received from an electricity grid is changed, the ramping commencement instruction including time information for specifying ramping commencement time, the ramping commencement time being a time point at which the ramping is to be commenced and being later than a demand response commencement time, the demand response commencement time being a time point at which the demand response event is to be commenced; and a control unit commencing the ramping at the ramping commencement time based on the ramping commencement instruction.

According to this aspect of the present invention, the commencement of the ramping is delayed with respect to the commencement of the demand response event. Consequently, the time period during which the load resource operates at a changed load is shortened. Accordingly, this aspect of the present invention suppresses reduction in functionality of a load resource brought about by demand response.

(12) Aspect 12 of the present invention is a load control method for controlling a load connected to an electricity grid, the load control method including: obtaining (i) time information for specifying demand response commencement time, the demand response commencement time being a time point at which a demand response event is to be commenced, and (ii) incentive information specifying incentive in relation to processing performance in ramping, the ramping being a process through which an amount of electricity received from an electricity grid is changed; determining ramping commencement time based on the time information and the incentive information, the ramping commencement time being a time point at which the ramping is to be commenced and being later than the demand response commencement time; and causing the ramping to be commenced at the ramping commencement time.

According to this aspect of the present invention, the commencement of the ramping is delayed with respect to the commencement of the demand response event. Consequently, the time period during which the load resource operates at a changed load is shortened. Accordingly, this aspect of the present invention suppresses reduction in functionality of a load resource brought about by demand response.

(13) Aspect 13 of the present invention is the load control method of aspect 12, wherein in the determining, the ramping commencement time is determined such that the incentive, which is an incentive paid to a demander using the load and changes in accordance with a time point at which the ramping is completed, is high.

(14) Aspect 14 of the present invention is the load control method of aspect 12, wherein the processing performance in the ramping is a time length between the demand response commencement time and the time point at which the ramping is completed.

(15) Aspect 15 of the present invention is the load control method of aspect 12 further including generating an instruction signal including the ramping commencement time; and transmitting the instruction signal to the load.

### REFERENCE SIGNS LIST

100 SOA
101 electric utility
200 DRC
201 load resource
102, 104, 105 communication tool
110, 220 communication unit
120 process management unit
130, 240 data storage
140, 231 timing management unit
230 DR operation management unit

1. A load control method for controlling a load connected to an electricity grid, the load control method comprising:
obtaining first time information for specifying demand response commencement time and second time information for specifying ramping completion time, the demand response commencement time being a time point at which a demand response event is to be commenced, the ramping completion time being a time point at which ramping in the demand response event is to be completed and being later than the demand response commencement time, the ramping being a process through which an amount of electricity received from the electricity grid is changed;
determining ramping commencement time based on the first time information and the second time information, the ramping commencement time being a time point at which the ramping is to be commenced, being later than the demand response commencement time, and being earlier than the ramping completion time; and
causing the ramping to be commenced at the ramping commencement time.

2. The load control method of claim 1, wherein
in the determining, the ramping commencement time is determined by using a probability of the ramping being completed before the ramping completion time when the commencement of the ramping is delayed with respect to the demand response commencement time, the probability being calculated by using the first time information and the second time information.

3. The load control method of claim 1, wherein
in the determining, the ramping commencement time is determined by using a probability of the demand response event being cancelled when the commencement of the ramping is delayed with respect to the demand response commencement time, the probability being calculated by using the first time information and the second time information.

4. The load control method of claim 1, wherein
in the determining, the ramping commencement time is determined by using a first probability and a second probability that are calculated by using the first time information and the second time information, the first probability being a probability of the ramping being completed before the ramping completion time when the commencement of the ramping is delayed with respect to the demand response commencement time, and the second probability being a probability of the demand response event being cancelled when the commencement of the ramping is delayed with respect to the demand response commencement time.

5. The load control method of claim 2, wherein
in the obtaining, characteristic information is obtained in addition to the first time information and the second time information, the characteristic information including at least one of characteristics of delay deriving from a communication network for transmitting a control signal for causing the ramping to be commenced and characteristics of time between the commencement and the completion of the ramping, and
in the determining, the probability is calculated by using the characteristic information in addition to the first time information and the second time information.

6. The load control method of claim 3, wherein
in the obtaining, characteristic information is obtained in addition to the first time information and the second time information, the characteristic information including information on current settings of the load and characteristics of a relationship between settings of the load and demand response events cancelled in the past, and
in the determining, the probability is calculated by using the characteristic information in addition to the first time information and the second time information.

7. The load control method of claim 1, wherein
in the obtaining, the first time information is obtained from an electric utility.

8. The load control method of claim 1, wherein
in the obtaining, the second time information is obtained from an electric utility.

9. The load control method of claim 1, wherein
in the obtaining, third time information for specifying demand response completion time is obtained in addition to the first time information and the second time information, the demand response completion time being a time point at which the demand response event is to be completed, and
the method further comprises
causing the load to commence a recovery process after the demand response event is completed.

10. A load control device for controlling a load connected to an electricity grid, the load control device comprising:
an obtaining unit obtaining first time information for specifying demand response commencement time and second time information for specifying ramping completion time, the demand response commencement time being a time point at which a demand response event is to be commenced, the ramping completion time being a time point at which ramping in the demand response event is to be completed and being later than the demand response commencement time, the ramping being a process through which an amount of electricity received from the electricity grid is changed; and
a determining unit determining ramping commencement time based on the first time information and the second time information, the ramping commencement time being a time point at which the ramping is to be commenced, being later than the demand response commencement time, and being earlier than the ramping completion time, wherein
the load control device causes the ramping to be commenced at the ramping commencement time.

11. An electric load device comprising:
a reception unit receiving a ramping commencement instruction being an instruction causing ramping in a demand response event to be commenced, the ramping being a process through which an amount of electricity received from an electricity grid is changed, the ramping commencement instruction including time information for specifying ramping commencement time, the ramping commencement time being a time point at which the ramping is to be commenced and being later than a demand response commencement time, the demand response commencement time being a time point at which the demand response event is to be commenced; and
a control unit commencing the ramping at the ramping commencement time based on the ramping commencement instruction.

12. A load control method for controlling a load connected to an electricity grid, the load control method comprising:
obtaining (i) time information for specifying demand response commencement time, the demand response commencement time being a time point at which a demand response event is to be commenced, and (ii) incentive information specifying incentive in relation to processing performance in ramping, the ramping being a process through which an amount of electricity received from an electricity grid is changed;
determining ramping commencement time based on the time information and the incentive information, the ramping commencement time being a time point at which the ramping is to be commenced and being later than the demand response commencement time; and
causing the ramping to be commenced at the ramping commencement time.

13. The load control method of claim 12, wherein
in the determining, the ramping commencement time is determined such that the incentive, which is an incentive paid to a demander using the load and changes in accordance with a time point at which the ramping is completed, is high.

14. The load control method of claim 12, wherein
the processing performance in the ramping is a time length between the demand response commencement time and the time point at which the ramping is completed.

15. The load control method of claim 12 further comprising:
generating an instruction signal including the ramping commencement time; and
transmitting the instruction signal to the load.
